(19) United States
(12) Patent Application Publication
(10) Pub. No.: US 2006/0145506 A1
(43) Pub. Date: Jul. 6, 2006

(54) Control panel and method for the production thereof

(76) Inventors: Marco Braun, Lug (DE); Volker Doll, Ranschbach (DE); Steve Kober, Treuen-Schreinersgrun (DE); Thomas Maier, Karlsruhe (DE); Dieter Thores, Karlsruhe (DE)

Correspondence Address: FAY KAPLUN & MARCIN, LLP, 15O BROADWAY, SUITE 702, NEW YORK, NY, 10038, US

(21) Appl. No.: 10/537,111

(22) PCT Filed: Dec. 1, 2003
(86) PCT No.: PCT/EP03/13509

§ 371 Date: Dec. 2, 2005

(30) Foreign Application Priority Data
Dec. 2, 2002 (DE) 102 57 161.9

(51) Int. Cl. B62D 25/14

(52) U.S. Cl. 296/70

(57) ABSTRACT

Described is a control panel, especially for motor vehicles. The control panel has a frame structure consisting of linear elements, regions of the frame structure, defined by the linear elements, being partially sealed using plastic plate elements. The plastic plate elements are connected to the linear elements with a material fit. This provides an integrally rigid control panel which can be produced in a simple and economical manner, and requires no costly, local reinforcements.

The present invention relates to a control panel and to a method for manufacturing same.

Various embodiments of control panels for automotive vehicles are known.

Usually control panels are secured for example to a cross-member arranged between the A-columns of an automotive vehicle. For this purpose, the control panels themselves generally have an additional support structure on which a covering of usually injection-moulded plastics material rests which can be covered on the side of the vehicle interior with a decorative layer.

The disadvantage of these known control panels lies in the fact that, as a result of their above-described structure, they are intensely weighty yet nevertheless, in view of the loads imposed on them, are in places under-dimensioned or over-dimensioned such that, for example, undesired fractures of the control panel can occur during a collision. However, the weight aspect is particularly crucial, the conventional cross-member moreover contributing to a great vehicle weight since it can on its own be as heavy as e.g. 6 to 8 kg.

To reinforce the control panels, it has up to now been usual to apply flat reinforcements in places, especially at particularly stressed places such as through holes for airbags, etc. However this produces the problem that the attachment of e.g. metal reinforcement sheets to a plastics part can be relatively expensive. Thus moreover for example, due to the different thermal expansion coefficient of the sheet metal and of the plastics material adjacent to it, this can lead to distortions in the control panel which are visible on the driver's side and thus represent a reduction in quality.

The object underlying the present invention, therefore, is to create a control panel and a method for manufacturing same which guarantees on the one hand control panel is produced capable of bearing a heavy load and that this control panel is moreover light in weight, cost-effective and reliable.

This object is accomplished by a control panel according to claim 1 and by a manufacturing method according to claim 8. Because a frame structure constructed from linear elements is provided in the control panel according to the invention, areas of the frame structure which are delimited by linear elements being sealed at least partially with plastic sheet elements and the plastic sheet elements being connected to the linear elements by an integral material connection, this object is accomplished with respect to the control panel.

The frame structure is here so calculated that the forces acting on the control panel can be absorbed mainly by its suitable structure. Naturally also the plastic sheet elements contribute to this, which also contribute to a stiffening of the control panel since it is connected in its edge regions by an integral material connection to the linear elements. As an “integral material connection” is here meant primarily remelting or melting of the liquid plastics material onto the linear elements. Alternatively, as an integral material connection can also be meant for example welding methods or other methods of “chemical fusion”, for instance with synthetic resins. The plastic sheet elements are here introduced preferably in an injection-moulding method as liquid plastics material into an appropriate mould in which the linear elements are placed in readiness.

Thus with the control panel according to the invention, for the first time a “comprehensive” reinforcement of the entire control panel is achieved, in contrast to the previously usual merely local reinforcements. Here in the design of the frame structure according to the invention, a special method also suggests itself which makes possible a construction of the control panel matched to the load.

Initially the whole cockpit region is here seen as a “large cuboid”. On this cuboid the loads are defined (e.g. “misuse forces”, such as can occur with the release of the air-bag or a “jacket alignment test” on the steering wheel). Then areas are also defined in which there should be a space, i.e. areas in which the cuboid has to be “cut out” in order for example to create legroom for the occupants of the vehicle. No structure can then be located there. In the designing of the profiles which then takes place, the main force flow in the rest of the cuboid is determined. On this a matched “grid profile” is modelled. Along these grid lines, linear elements of a frame structure are then arranged. Additionally, in the areas between the linear elements or respectively “force flow lines”, bridging areas are provided, here the plastic sheet elements according to the invention. In this way an optimised support structure is obtained which only exists where it is really necessary for force reasons. What is advantageous about this is that reinforcements are then only located where they are actually needed, and through the optimised design the total weight of the automotive vehicle is reduced, and possibly a cross-member can even be dispensed with, costs can be saved and more structural space is available. By this means more utilisable space is generated in the cockpit area e.g. for an air conditioning system, electronic components, glove boxes; and this provides much greater design scope when the control panel is being developed.

The method according to the invention for manufacturing a control panel, provides for linear elements to be introduced into the mould cavity of an injection-moulding, compression-moulding or foaming tool and then to be surrounded in the mould at least partially with the plastics material (which primarily forms the later plastic sheet elements), forming the control panel. In the injection-moulding method according to the invention, remelting of the linear elements takes place; when the injection-moulded plastic cools, an integral material connection is produced; similar conditions are achieved with a compression mould. In a foaming mould, a foaming process is initiated e.g. by means of a plurality of components, by which means for example foaming of the mould or of its cavity with polyurethane foam takes place; this surrounds the linear elements at least partially such that here too an integral material connection is produced between the linear elements and the foamed plastics material after the latter has set.

Advantageous developments of the subject matter mentioned in the main claims are given in the dependent claims.

An advantageous development of the control panel provides for the cross-section of the linear elements, when installed in the control panel, to be U-shaped, round, oval or polygonal. Basic closed or open cross-sections can be used here. It must be noted here that the linear elements in their installed state can also be used for guiding cables or for air conduction. Particularly advantageous is for example a U profile which is open towards the outside of the control panel, such that for example bundles of cables can be introduced into this U profile so as to be easily accessible from the outside.

In addition to profiles which have simple (continuous) cross-sectional shapes, more complicated structures can also be used if special tasks are to be fulfilled. Thus it is possible for example for the linear element to be a strip of a honeycomb sandwich structure. Here for example a plurality of adjacent honeycomb octagons is provided which are enclosed between two cover plates. Thus a very light structure is produced with very good mechanical strength properties.

A special way of attaching the injection-moulded, melted-on or extrusion-coated plastics material to the linear elements is for example for the linear elements to have special webs on their outer sides. These serve first of all as reinforcement for the linear element itself but through these also an enlargement of the coupling surface to the plastics material to be injected is given. It has been demonstrated that, for stability reasons, it is particularly advantageous to arrange each of the webs inclined (e.g. 45°) with respect to the main direction of extension of the linear element itself in order thus to achieve the highest possible stability and to integrate the linear element into the control panel as well as possible.

A variety of materials can be considered as materials for the elements. First of all the linear elements can consist of sheet metal, for example steel sheet, perforated sheet metal or for instance aluminium or magnesium. However it is naturally also possible to provide fibre materials. These can be used basically as strips of woven or knitted fabrics, which only develop their complete strength in the extrusion-coating process. It is also possible for the linear elements to be constructed from continuous fibres. These are for example tubes of continuous fibres; as basic fibres can be used here glass fibres or even carbon fibres which are bonded with a thermoplastic plastics material even before injection-moulding. By the subsequent extrusion-coating with the plastics material which forms the later plastic sheet elements, good fusion of these linear elements in the total structure is produced.

The plastic sheet elements can be formed from various plastics materials. For example it is possible for them to formed from a thermoplastic plastic, e.g. from PP30LGF, a polypropylene material which has long fibre portions. These long fibre portions are glass fibres; in the injection-moulding method according to the invention, these glass fibres preferably have a length of 10 mm, in the compression-moulding method according to the invention preferably a length of 25 mm. Alternative plastics materials for this purpose are e.g. polyamides PA, ABS, PC, ABS/PC, polyimides, PEEK, PEU, PPS, PEI, PSU, PESU, PPSU and PTFE. Naturally other plastics materials are also possible, for instance duroplastic plastics.

The control panel according to the invention has the advantage that it pursues a “comprehensive” approach in the stability of the control panel. No purely local reinforcements are introduced but the entire structure has the desired stiffness. The support formed according to the invention can in addition, if this is desired for aesthetic reasons, be covered with a decorative layer arranged towards the vehicle interior. This can be for example a slush skin, leather or also a synthetic fabric, textile, a cast skin or a sprayed skin. What is advantageous here at any rate is, in contrast to known concepts, that the decorative layer can be glued directly to a support structure; no additional structural elements such as cross-struts between a cross-member of an automotive vehicle and a supporting plastic skin for the decorative layer are necessary.

The method according to the invention for manufacturing a control panel has various advantageous embodiments.

Thus it is possible for example for the linear elements to be introduced into the mould as a previously practically complete frame. This is possible for example when a prefabricated metal frame is inserted into a mould.

With reference to the manufacturing costs, it is advantageous however for the linear elements to be inserted into the mould as individual parts. To this end, for example, pieces of a continuous material (e.g. a tube of fibre materials) can be separated which are then inserted individually into the mould and only form a finished frame when they are surrounded by the plastics material injected into the mould.

A particularly advantageous development provides for strips of a fibre material, for example a woven fabric, a non-woven fabric or the like, to be inserted into a depression of a first mould half of an injection mould and then a second mould half, which has a bulge corresponding to the depression, is brought into alignment with the first mould half in such a way that a gap remains between the two, at least in regions, and then a plastics material is injected into the mould cavity. During this process, the strip of fibre material is brought by the mould itself (i.e. by the depression or the bulge of the mould halves) into the correct shape and then extrusion-coated. This produces a very cost-effective arrangement which makes possible stable cross-sections of the linear elements. To ensure better flowing of the plastics material in the region of the inserted strip, it is advantageous for gaps which are e.g. 2 to 4 mm larger than the thickness of the strip also to be provided between the corresponding depressions or bulges. The temperature of the mould (i.e. the halves of the mould) is here roughly at the level of the softening temperature of the plastics material to be injection-moulded, that is e.g. approximately 160° C. for polypropylene. Naturally the equivalent method is also possible in a compression mould. Here the fabric, impregnated with thermoplastic plastics material, of the strip of fibre material would be brought to its softening temperature, i.e. roughly also approximately 160° C. for polypropylene. During compression-moulding, the temperature of the mould or of the mould halves would be approx. 70° C. in order to obtain a satisfactory end product.

The invention shown here may be applied in particular to automotive vehicles. It is an obvious idea here for the force-absorbing frame structure of the control panel to be directly connected to an end wall and/or the body of the vehicle. No connection to a cross-member has to be produced in order to support the control panel. Furthermore, what can be achieved by correspondingly strict design of the frame structure is that the cross-member may even be dispensed with and thus further weight saved.

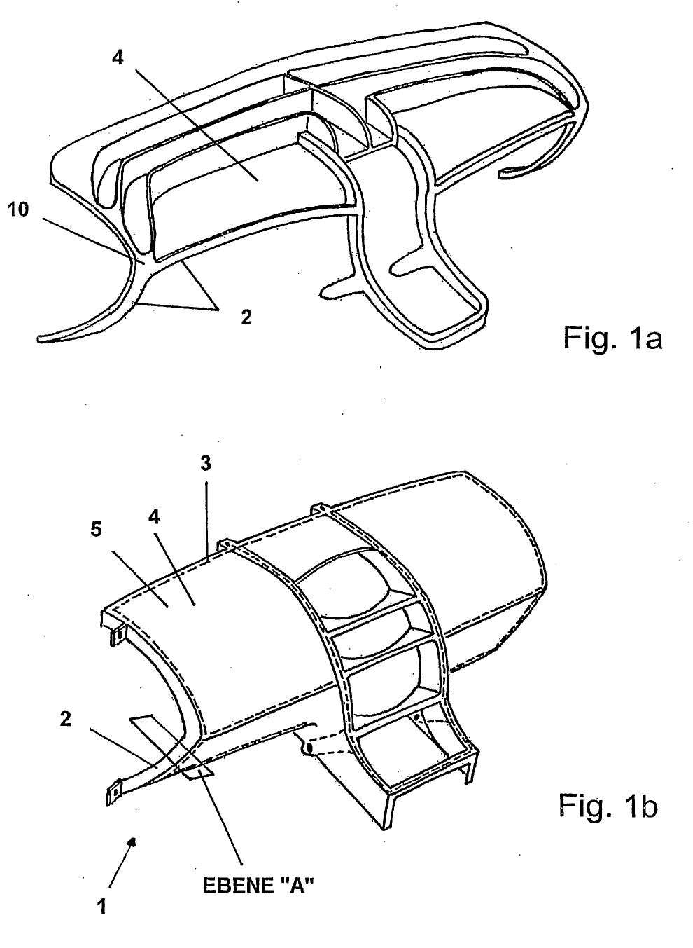

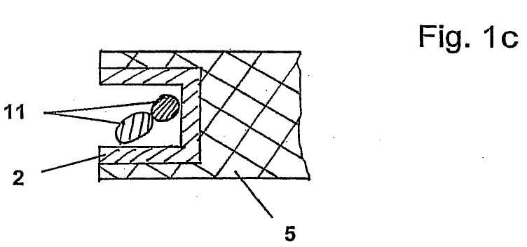

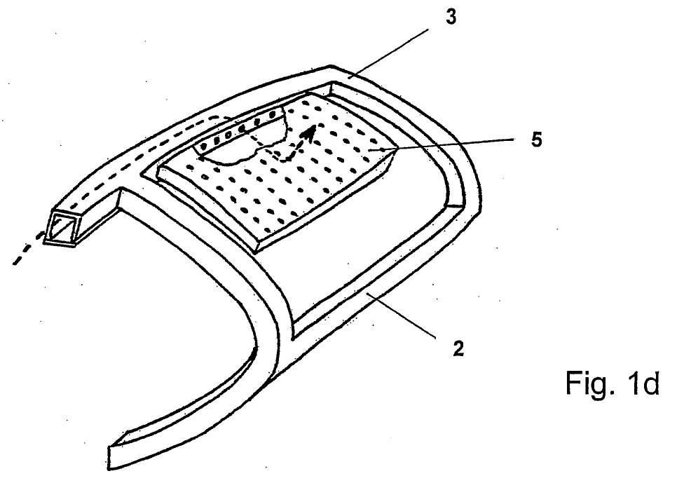

The frame structure could serve for air conduction or as a cable guide. It would also be conceivable to use the frame structure as an air distributor in large-surface discharge fields (see FIG. 1b).

Further advantageous developments are quoted in the remaining dependent claims.

The invention is now explained with the aid of a number of figures. These show:

FIG. 1a a frame structure according to the invention,

FIG. 1b a control panel according to the invention,

FIG. 1c a section according to cutting plane A from FIG. 1b,

FIG. 1d a frame structure used for air conduction with flat discharge fields in the region of the plastic sheet elements,

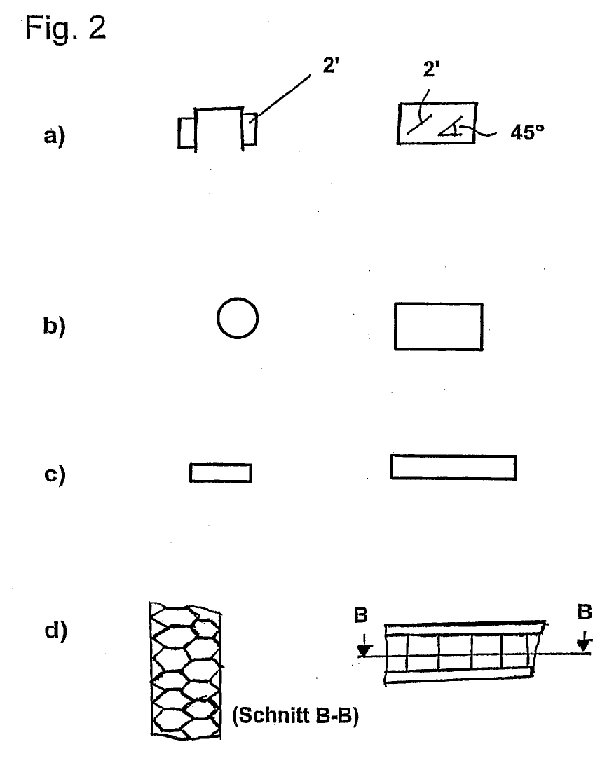

FIGS. 2a to 2d various embodiments of linear elements in cross-section and in side view, as well as

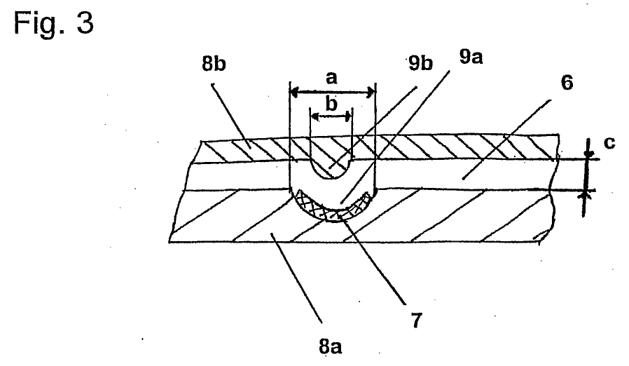

FIG. 3 a cross-section through an injection mould according to the invention for producing a control panel according to the invention.

FIG. 1a shows a frame structure 3 according to the invention. This comprises linear elements 2 which are brought together at corner points 10. Areas 4 can be seen which are delimited or enclosed by linear elements 2. The frame structure shown in FIG. 1a is the frame structure of a control panel 4 for an automotive vehicle.

In FIG. 1b is shown a complete control panel 1 according to the invention. This has the frame structure 3 (shown separately in FIG. 1a for reasons of comprehensibility) with linear elements 2. The areas 4 of the frame structure which are delimited by the linear elements 2 are sealed at least partially with plastic sheet elements 5. The plastic sheet elements are here connected to the linear elements 2 by an integral material connection. The integral material connection was achieved here by injecting a thermoplastic plastics material which, after curing, forms the plastic sheet elements; during this process there is melting or remelting of this plastic to the linear elements such that an integral material connection is produced.

The control panel shown in FIG. 1a can in addition be covered with a decorative layer, e.g. a foam film, or with leather or a textile decorative layer.

The linear elements 2 are realised in the embodiment of FIG. 1b as U-shaped continuous parts formed from sheet metal.

This is clear from the section shown in FIG. 1c along the cutting plane A. Here it can be seen how the plastic sheet elements 5 are injected around the U-shaped cross-section such that only the open flank of the “U” is open towards the outside. Thus it is possible, for example, to position cables etc. inside the U. Naturally also closure elements, which are not shown, can later be provided at the open side of the U in order to prevent the cables 11 from slipping out. The plastic sheet element comprises a polyolefin composite material, here PP3OLFG, i.e. a polypropylene with inserted fibres which have a length of 10 mm (in the injection-moulding method) and 25 mm (in the compression-moulding method).

FIG. 1d shows a frame structure 3 constructed from linear elements 2. This frame structure has, at least in regions, linear elements 2 which are hollow inside and which at their lateral attachment to the plastic sheet elements 5 have holes for an airflow. The plastic sheet element 5 has a large number of discharge apertures towards the vehicle interior such that the air masses guided through the hollow linear elements 2 can flow in a diffuse and planar manner out of the plastic sheet element 5.

FIG. 2 shows various possibilities for the geometry of linear elements. Here, respectively, on the left-hand side the cross-section is shown and on the right-hand side a side view of a piece of the respective embodiment of the linear element.

In FIG. 2a a U-shaped cross-section is shown on the left (as in FIG. 1c), however with the addition that webs 2′ also protrude on both sides of the members of the U. From the side view on the right in FIG. 2a it is clear that these webs are inclined, and specifically by roughly 45° with respect to the horizontal. During extrusion-coating with a plastic sheet element, this produces even better attachment of the linear element to the plastic sheet element 5.

In FIG. 2b is shown a circular cross-section of a linear element. From FIG. 2b on the right it is clear that this is a “tube piece” with a constant external diameter. This tube cross-section can be produced for example from sheet metal or perforated sheet metal; it is naturally also possible for this to be a tube “wound” from fibres.

In FIG. 2c is shown a flat cross-section. Here on the left side can be recognised the rectangular cross-section of the linear element. This can be formed either from plastics material or also from metal or a fibre material (woven or non-woven). This variant suggests itself in particular for the manufacturing variant shown later in FIG. 3.

Finally, FIG. 2d shows a honeycomb sandwich structure. Here in FIG. 2d a side view is shown on the right. It can be seen here that upright honeycomb cells (octagonal) are apparent which are provided with an upper and a lower cover panel (this panel could also be a fabric impregnated with thermoplastic plastics material). This is even clearer from the section B-B which can be seen on the left-hand side.

The control panel according to the invention can be manufactured in various ways. To this end, it is particularly simple for linear elements to be introduced into the mould cavity of an injection mould and then be remelted with plastics material at least partially in the injection mould, forming the control panel. Here one variant provides for the linear elements to be inserted as a prefabricated self-supporting frame (which would look roughly like the frame in FIG. 1a) and be formed from pressure-cast aluminium.

However it can be very cost-effective for the linear elements to be introduced into the mould cavity as individual parts. To this end, a particularly advantageous manufacturing variant is provided which is now explained in greater detail in FIG. 3.

FIG. 3 shows schematically the cross-section of an injection mould. This has a first mould half 8a and a second mould half 8b lying on top of same. Between these mould halves is a mould cavity 6 which has a gap height c of 1-6 mm.

The first mould half 8a has a depression 9a which is roughly semicircular in cross-section. The second mould half 8b has in vertical alignment a bulge 9b which has a complementary shape but is significantly smaller. Depression 9a has a cross-sectional width of a, the bulge 9b has a cross-sectional width of b. b is smaller than a as a function of c.

Now it is possible to lay a strip 7 comprising intertwined fibres (a woven/non-woven fibre fabric) along the depression 9a, such that this strip assumes substantially the semicircular cross-section of the depression 9a. Then the second mould half 8b is lowered to the minimum gap c. Thereafter, there is injection-moulding of a thermoplastic plastics material in the mould cavity 6, the strip being impregnated and moreover plastic sheet elements 5 being formed in the cavity 6 during this process. In this way a control panel according to the invention may be manufactured in a very cost-effective manner.

The control panel according to the invention has the advantage that, as a result of its inherent stability, (i.e. on account of the frame structure) it is significantly more stable than previous control panels. It can be connected directly to the end wall and/or the body of an automotive vehicle. It is no longer necessary to support the control panel according to the invention on a cross-member of the automotive vehicle.

In what follows, particularly important points of the invention will be emphasised again separately.

It is particularly advantageous that with the present structure, the integration of linear elements in the form of hollow profiles is possible, such that cavities extending inside the profiles can also be used for guiding e.g. cables or even airflows for interior ventilation. Thus reference is again made in particular to FIG. 1d. The arrangement there for ventilating the interior may for example be so manufactured that the ventilation ducts which run through the matrix material are achieved by “blowing through” this material before it finally sets; for this purpose raised portions are preferably to be provided in the shaping of the mould to form the air outlets.

A particularly important aspect of the invention is that with a support according to the invention especially the stability of the control panel is increased; by the possible elimination of a cross-member, lightweight construction requirements are met.

This is achieved preferably in that as linear elements, for example bundles of continuous fibres or strips of mat material are inserted, the mat material being embodied as a single-layer or multilayer non-woven or woven fabric. Underlying this is the idea of the invention that it is expensive and also weight-intensive to design a stable control panel with the same strength overall, in order at any event to have sufficient stability also at the point which is the most severely loaded.

In this context, reference is made again in retrospect to FIG. 1a in which the lines extending there reproduce the flow of force in the control panel. It is possible now to insert e.g. strips of fibre material into these force flow lines. At the force flow lines, where particularly high forces act, particular adaptations can then be made (either through more material or through special materials).

As the fibre material, a number of materials have proved to be particularly preferred. Thus it is possible for example to insert strips of woven glass fibre mats. These can for example be pre-impregnated with a thermoplastic material or even contain thermoplastic threads, for example polypropylene threads, so that incorporating them subsequently in the matrix material is even more successful (such products can be obtained for example from the company “Vetrotex”). The insertion of such strips (or “mats cut to size”) with open areas, i.e. virtually in “mask form”, suggests itself in particular when the support is to be also subject to great torsional strain.

In particular for absorbing tensile load (e.g. in replacing a cross-member), it can also be possible to provide glass in continuous glass fibres or whole bundles of continuous glass fibres. Here the fibre material is not a woven or non-woven fabric but a bundle of individual fibres which can possibly also be attached to the vehicle body and thus take on the function of a cross-member.

In particular, it is therefore advantageous that the material or the quantity of this material can be selected (according to the load).

In this connection some more examples will be mentioned. The matrix material which forms the plastic sheet elements according to the invention, which at least partially surround the linear elements, is preferably a relatively “stable” material which penetrates the fibre material at least partially and through this connection an extremely stable but nevertheless lightweight structure is produced. It is here generally not sufficient to simply “foam in” the material; a connection using stable plastics materials such as polypropylene (e.g. PP30, propylene reinforced with 30 mm long glass fibres (polypropylene 30 LGF)) is the most possible; alternatively e.g. reinforced or unreinforced polyamides are also possible. Here the modulus of elasticity in tension of the matrix material should preferably be more than 2000 N/m², in particular preferably more than 3500 N/M². For particularly extreme applications however, it is also possible to achieve material with elasticity moduli of 22000 N/m² and more; here for example sandwich structures comprising a plurality of layers of glass fibre mats with different separating layers are used.

There are also different possible ways of connecting the fibre material to the matrix material.

In the case of parts not subject to such great stress, it can for example be sufficient to introduce melts of PP30 LGF into a mould (such as is shown for example in FIG. 3) by injection moulding; however due to the injection-moulding process a shortening of the fibres will take place which has a rather negative effect on the stability.

As an alternative to this, it is naturally also possible to place into an appropriate two-part mould the melts directly from the extruder e.g. in the form of strands and then to press the mould together, the penetration of the fibre material with the matrix material then taking place (this method is known as “strand deposition”). In principle according to the invention all those methods can be used in which, for example, in a strip of fibre material can be connected with a matrix material in a closed mould. Here it is naturally possible and advantageous, as shown in FIG. 3, to predetermine by the shaping of the mould the contour of the strip and thus of the later component. It is also possible, unlike the more or less circular arrangements shown in FIG. 3, also to provide more angular arrangements, even arrangements which are polygonal in cross-section; naturally it is also possible to dispense with a corresponding contouring (in some circumstances with small losses of the load-bearing capacity).

In principle however it is essential to the invention that in the case of particularly high loads, or alternatively adapted to the type of load, specific material can be used (e.g. continuous fibres in the case of tensile load or three-dimensionally bent mat material if e.g. an additional strong torsional load is to be absorbed).

1-14. (canceled)

15. A control panel, comprising:
a frame structure constructed from linear elements, areas of the frame structure which are delimited by the linear elements being sealed at least partially by sheet elements, the sheet elements being connected to the linear elements by an integral material connection, the sheet elements being composed of a thermoplastic plastic material, the linear elements being composed of a fibre material and being impregnated with the same thermoplastic plastics material as the sheet elements.

16. The control panel of claim 15, wherein an automotive vehicle includes the control panel.

17. The control panel according to claim 15, wherein the linear elements, when installed in the control panel,. have one of the following cross-sections: a U-shaped cross-section, a round cross-section, an oval cross-section and a polygonal cross-section.

18. The control panel according to claim 15, wherein each of the linear elements is a strip of a honeycomb sandwich structure.

19. The control panel according to claim 15, wherein the control panel is covered with a decorative layer substantially over an entire surface of an upper side of the control panel.

20. A method for manufacturing of a part, comprising:
inserting linear elements into a mold cavity of a mold, the mold having a first half and a second half, the first half having a depression and the second half having a bulge corresponding to the depression;
at least partially surrounding the linear elements by a plastics material in the mold to form the part;
inserting strips of a fibre material into the depression;
bringing the second half into alignment with the first half so that at least in regions a gap remains between the first and second halves; and
injecting the plastics material into the cavity.

21. The method according to claim 20, wherein the part is a control panel.

22. The method according to claim 20, wherein an automotive vehicle includes the part.

23. The method according to claim 20, wherein the mold is one of an injection mold and a compression mold.

24. The method according to claim 20, wherein the linear elements are a prefabricated self-supporting frame.

25. The method according to claim 20, wherein the linear elements are individual pieces.

26. The method according to claim 20, wherein the linear elements are one of bundles of continuous fibres and strips of mat material, the mat material being embodied as a fabric, the fabric being one of a single-layer fabric and a multilayer fabric, the fabric being one of a non-woven fabric and a woven fabric.

27. A control panel, manfuctured according to the steps of claim 20.

28. An automotive vehicle, comprising:
a control panel including a frame structure constructed from linear elements, areas of the frame structure which are delimited by the linear elements being sealed at least partially by sheet elements, the sheet elements being connected to the linear elements by an integral material connection, the sheet elements being composed of a thermoplastic plastic material, the linear elements being composed of a fibre material and being impregnated with the plastics material,
wherein the frame structure is directly connected of at least one of an end wall of the vehicle and a body of the vehicle.
